(19) United States
(12) Patent Application Publication
(10) Pub. No.: US 2016/0321644 A1
(43) Pub. Date: Nov. 3, 2016

(54) TRANSACTION PROCESSING METHOD AND ASSOCIATED APPARATUS

(71) Applicant: Tencent Technology (Shenzhen) Company Limited, Shenzhen (CN)

(72) Inventors: Kai ZENG, Shenzhen (CN); Yu LI, Shenzhen (CN)

(21) Appl. No.: 15/188,892

(22) Filed: Jun. 21, 2016

Related U.S. Application Data
(63) Continuation of application No. PCT/CN2014/094163, filed on Dec. 18, 2014.

(30) Foreign Application Priority Data
Apr. 3, 2014 (CN) 201410133603.9

(51) Int. Cl. G06Q 20/32

(52) U.S. Cl. CPC G06Q 20/3276; G06Q 20/3274

(57) ABSTRACT

A first device acquires target object information and generates a graphic code according to the target object information and corresponding first user account information. The first device displays the graphical code on the screen so that a second device scans the graphic code and uploads the graphic code to a remote server, which extracts the target object information and the first user account information from the graphical code, carries out a commercial transfer operation on the target object information while returning numerical commercial value transfer progress information to the first device during the process of the operation. The first device then displays the progress information on the screen. Sometimes, users of the first device and the second device exchanges respective user account information of a social network application via the remote server with each other so that the two enter a chat session with each other from the respective devices.

### RELATED APPLICATIONS

This application is a continuation application of PCT Patent Application No. PCT/CN2014/094163, entitled “TRANSACTION PROCESSING METHOD AND ASSOCIATED APPARATUS” filed on Dec. 18, 2014, which claims priority to Chinese Patent Application No. 201410133603.9, entitled “Transaction Processing Method and Apparatus” filed on Apr. 3, 2014, both of which are incorporated by reference in their entirety.

### TECHNICAL FIELD

The disclosed implementations relate generally to the field of network technologies, and in particular, to transaction processing method and apparatus.

### BACKGROUND

With the popularization of intelligent terminals, graphic codes such as QR codes are applied to various scenes such as product anti-counterfeiting, advertisement pushing, numerical commercial value transfer implemented between a buyer and a seller and the like. The graphic code may be generated according to the product anti-counterfeiting information, the advertisement to be pushed or the target object information of the seller used for acquiring the numerical commercial value and the like, and is scanned by a terminal through a camera to acquire the information in the graphic code, thus avoiding manual input of a user and making the operations simple, convenient and fast.

During the process of numerical commercial value transfer implemented between the buyer and the seller, a device of the seller generates a graphic code comprising target object information according to the target object selected by the buyer. A terminal of the buyer scans the graphic code, acquires the target object information, and sends the target object information to a server. Afterwards, the server sends the target object information to a numerical commercial value transfer server. The numerical commercial value transfer server transfers the numerical commercial value needing to be transferred from the account of the buyer to the account of the seller according to the target object information, to finish the numerical commercial value transfer. At this time, the numerical commercial value transfer server may send a numerical commercial value transfer finishing message to the device and to the terminal. The device and the terminal, after receiving the numerical commercial value transfer finishing message, may display the numerical commercial value transfer finishing message so as to indicate that the numerical commercial value transfer is finished.

After the graphic code is generated, the device displays the graphic code all the time, and switches to display the numerical commercial value transfer finishing message when the numerical commercial value transfer finishing message is received. That is, the device does not make any prompt before finishing the numerical commercial value transfer, and the buyer and the seller cannot know the current numerical commercial value transfer progress from the device. Further, when a failure occurs during the numerical commercial value transfer process, the device still displays the graphic code and cannot prompt the occurred failure in time, so that the seller cannot eliminate the failure in time, which is easy to cause loss to the buyer or to the seller, and has poor security.

### SUMMARY

The above deficiencies and other problems associated with the conventional approach are reduced or eliminated by the invention disclosed below. In some embodiments, the present application is implemented in a first device that communicates with a second device wirelessly via a remote server, each device having one or more processors, memory and one or more modules, programs or sets of instructions stored in the memory for performing multiple functions. Instructions for performing these functions may be included in a computer program product configured for execution by one or more processors.

One aspect of the present application involves a computer-implemented method of performing a transaction related to a target object at a first device having a screen, one or more processors, and memory storing one or more program modules to be executed by the one or more processors. The computer-implemented method includes: acquiring target object information associated with a numerical commercial value transfer operation; generating a graphic code according to the target object information and first user account information associated with the first device; displaying the graphical code on the screen so that a second device can scan the graphic code and upload the graphic code to a server, wherein the server is configured to extract the target object information and the first user account information from the graphical code, carry out the numerical commercial value transfer operation on the target object information, and return numerical commercial value transfer progress information to the first device during the process of the numerical commercial value transfer operation; and receiving and displaying the numerical commercial value transfer progress information on the screen. In accordance with some embodiments, a first device includes one or more processors, memory, a wireless signal transceiver, and one or more programs; the programs are stored in the memory and configured to be executed by the processors and the programs include instructions for performing the operations of the method described above. In accordance with some embodiments, a non-transitory computer readable storage medium has stored therein instructions which, when executed by a first device, cause the first device to perform the operations of the method described above.

Another aspect of the present application involves a method performed at a first mobile device of exchanging contact information with a second mobile device, each mobile device having a screen, one or more processors, and memory storing one or more program modules to be executed by the one or more processors. The computer-implemented method includes: retrieving first user account information from its memory; generating a graphic code corresponding to the first user account information and displaying the graphic code on its screen, wherein the second mobile device is configured to scan the graphic code and upload the graphic code and second user account information to a remote server; receiving the second user account information from the remote server; replacing the graphic code with a display of the second user account information on its screen; and in response to detecting a user instruction, initiating a chat session with the second mobile device. In accordance with some embodiments, a first mobile device includes one or more processors, memory, a wireless signal transceiver, and one or more programs; the programs are stored in the memory and configured to be executed by the processors and the programs include instructions for performing the operations of the method described above. In accordance with some embodiments, a non-transitory computer readable storage medium has stored therein instructions which, when executed by a first mobile device, cause the first device to perform the operations of the method described above.

### BRIEF DESCRIPTION OF DRAWINGS

The aforementioned implementation of the invention as well as additional implementations will be more clearly understood as a result of the following detailed description of the various aspects of the invention when taken in conjunction with the drawings. Like reference numerals refer to corresponding parts throughout the several views of the drawings.

In order to illustrate the technical solutions in some embodiments of the present application more clearly, the accompanying drawings used in the descriptions of the embodiments will be described simply hereinafter. Apparently, the accompanying drawings described hereinafter are merely some embodiments of the present application. Those skilled in the art may also figure out other accompanying drawings according to the accompanying drawings without any creative work.

FIG. 1 is a structural schematic diagram of a transaction processing system according to some embodiments of the present application;

FIG. 2 is a composition block diagram of the transaction processing system according to some embodiments of the present application;

FIG. 3 is a flow chart of a transaction processing method performed at the first device of the transaction processing system according to some embodiments of the present application;

FIG. 4 is a flow chart of a transaction processing method performed at the first server of the transaction processing system according to some embodiments of the present application;

FIG. 5 is a flow chart of a transaction processing method according to some embodiments of the present application;

FIG. 6 is a schematic diagram of a first device display interface according to some embodiments of the present application;

FIG. 7 is a schematic diagram of a first device display interface according to some embodiments of the present application;

FIG. 8 is a structure block diagram of a transaction processing apparatus according to some embodiments of the present application;

FIG. 9 is a structural block diagram of a transaction processing apparatus according to some embodiments of the present application;

FIGS. 10A-10D are structural block diagrams of two mobile devices exchanging user account information via a remote server according to some embodiments of the present application; and

FIG. 11 is a flow chart of the user account information exchange method performed at the two mobile devices and the remote server according to some embodiments of the present application.

### DETAILED DESCRIPTION

The technical solution in some embodiments of the present application will be clearly and completely described with reference to the accompanying drawings hereinafter. Apparently, the embodiments described here are only some embodiments, rather than the whole embodiment embodiments of the present application. Based on the embodiments in the present application, all other embodiments made by a person of ordinary skill in the art without any creative effort, shall fall within the protection scope of the present application.

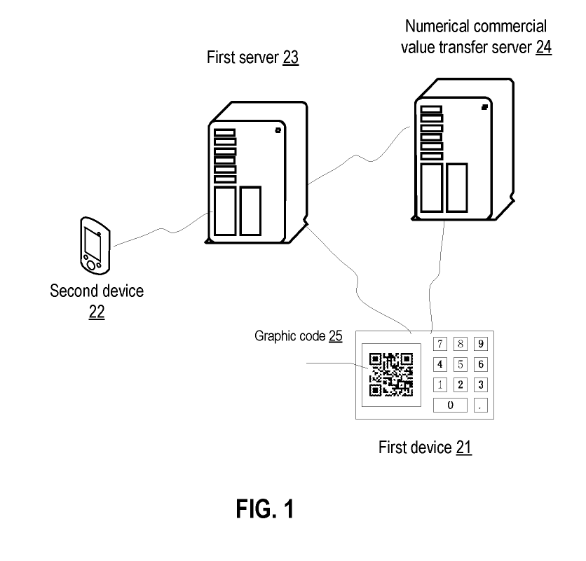

FIG. 1 is a structural schematic diagram of a transaction processing system according to some embodiments of the present application. Referring to FIG. 1, the transaction processing system comprises a first device 21, a second device 22, a first server 23 and a numerical commercial value transfer server 24. The second device 22 and the first server 23 are connected through a network. The first server 23 and the numerical commercial value transfer server 24 are connected through a network. The first server 23 and the first device 21 are connected through a network. Moreover, the numerical commercial value transfer server 24 and the first device 21 are connected through a network. The first device 21 is used for generating a graphic code 25 according to the target object information associated with a numerical commercial value transfer operation and first user account information associated with the first device 21. The second device 22 is used for scanning the graphic code 25 generated by the first device 21 and uploading the graphic code 25 to the first server 23. The first server 23 is used for extracting the target object information and the first user account information from the graphic code and sending the target object information and the first user account information to the numerical commercial value transfer server 24. The numerical commercial value transfer server 24 is used for carrying out the numerical commercial value transfer operation on the target object information, and sending numerical commercial value transfer progress information to the first device 21 during the process of the numerical commercial value transfer operation on the target object information, so that the first device 21 displays the numerical commercial value transfer progress information. In some embodiments, the first device 21 is a point of sale (POS) machine and the second device is a mobile phone that has a camera.

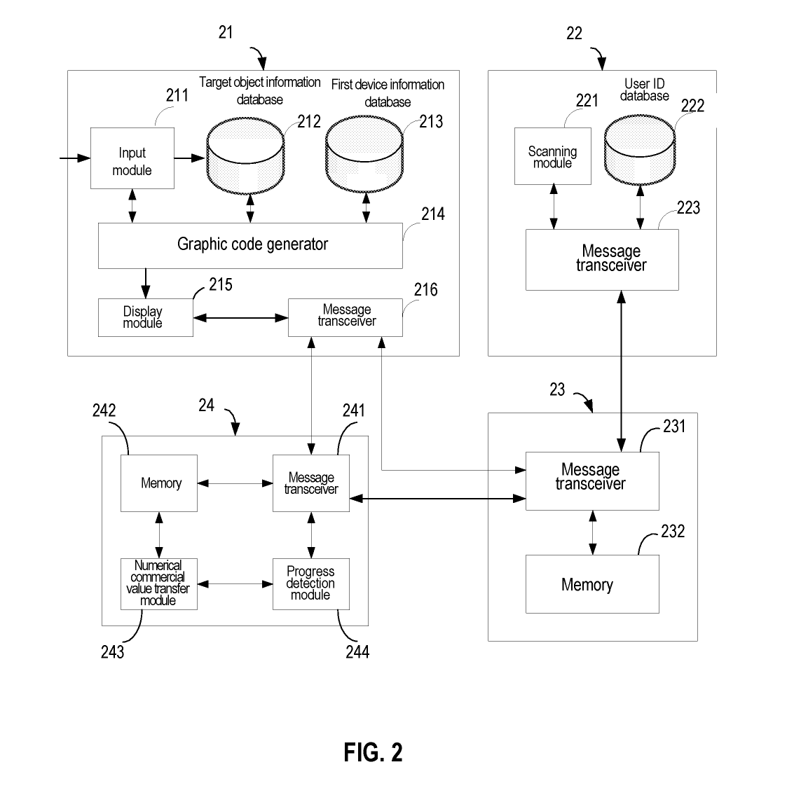

FIG. 2 is a composition block diagram of the transaction processing system according to some embodiments of the present application. Referring to FIG. 2, each component in the transaction processing system will be introduced hereinafter.

The first device 21 comprises an input module 211, a target object information database 212, a first device information database 213, a graphic code generator 214, a display module 215 and a message transceiver 216. The input module 211 is used for acquiring such information as numerical commercial value and target object number and the like inputted by a first device user through a keyboard. The first device may further be equipped with a scanner to scan a bar code or a QR code on the target object. The input module 211 parses the scanned bar code or QR code to obtain the target object information. The target object information database 212 is used for providing the target object information such as the target object number, a numerical commercial value corresponding to the target object, target object description information and the like. When the input module 211 acquires the target object number, the target object information corresponding to the target object number may be looked up from the target object information database 212. The first device information database 213 is used for storing first user account information associated with the first device. The message transceiver 216 is used for receiving a message sent by the first server or the numerical commercial value transfer server. The message transceiver 216 is further used for sending a message to the first server or the numerical commercial value transfer server. The graphic code generator 214 is used for generating the graphic code according to the target object information and the first user account information associated with the first device. The display module 215 is used for displaying the generated graphic code, so that other devices may scan the graphic code. The display module 215 is further used for displaying the numerical commercial value transfer progress information received by the first device through the message transceiver 216.

The second device 22 comprises a scanning module 221, a user ID database 222 and a message transceiver 223. The scanning module 221 is used for scanning the graphic code generated by the first device. The user ID database 222 is used for maintaining the registration mechanism of the second device. The message transceiver 223 is used for sending the scanned graphic code to the first server.

The first server 23 comprises a message transceiver 231 and a memory 232. The message transceiver 231 is used for receiving a numerical commercial value transfer request sent by the second device, sending the target object information and first user account information associated with the first device to the numerical commercial value transfer server, and sending a target object information extracting success message to the first device 21. The memory 232 is used for correspondingly storing the acquired target object information and the acquired first device information.

The numerical commercial value transfer server 24 comprises a message transceiver 241, a memory 242, a numerical commercial value transfer module 243 and a progress detection module 244.

The message transceiver 241 is used for receiving the target object information and first user account information associated with the first device sent by the first server. The message transceiver 241 is further used for receiving a numerical commercial value transfer stop request sent by the first device. The memory 242 is used for correspondingly storing the target object information and first user account information associated with the first device. The numerical commercial value transfer module 243 is used for carrying out the numerical commercial value transfer operation according to the target object information and first user account information associated with the first device. The progress detection module 244 is used for monitoring the progress of the numerical commercial value transfer operation carrying out by the numerical commercial value transfer module 243, so as to determine the progress of the numerical commercial value transfer operation. The message transceiver 241 is further used for sending the numerical commercial value transfer progress information to the first device according to the progress of the numerical commercial value transfer operation.

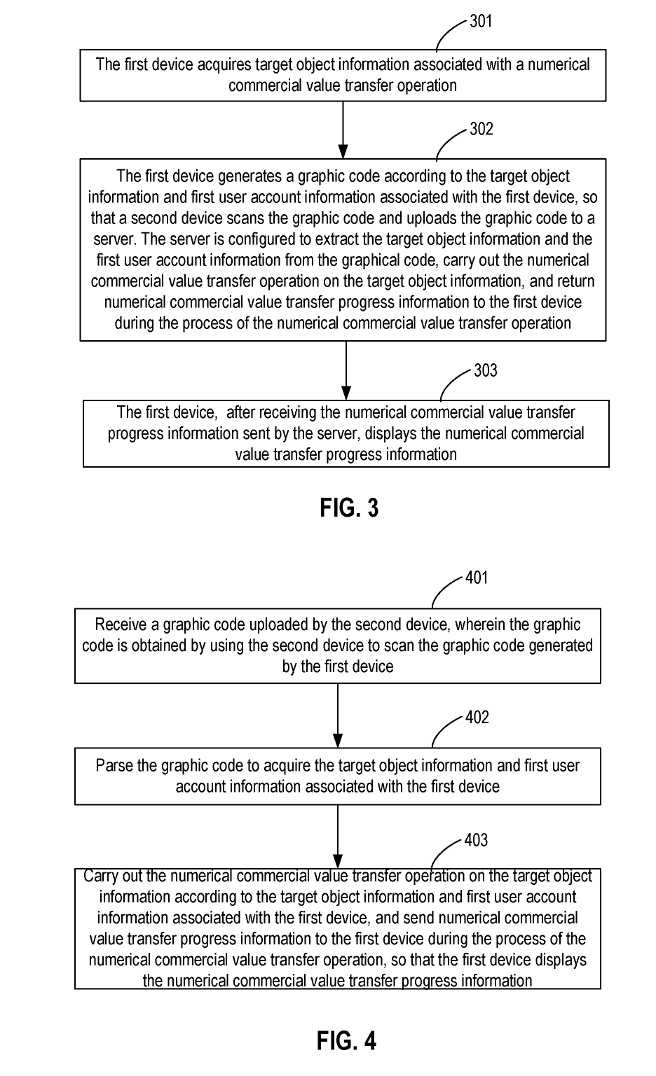

FIG. 3 is a flow chart of a transaction processing method performed at the first device according to some embodiments of the present application. Referring to FIG. 3, the method comprises:

Step 301: The first device acquires target object information associated with a numerical commercial value transfer operation.

Step 302: The first device generates a graphic code according to the target object information and first user account information associated with the first device, so that a second device scans the graphic code and uploads the graphic code to a server. The server is configured to extract the target object information and the first user account information from the graphical code, carry out the numerical commercial value transfer operation on the target object information, and return numerical commercial value transfer progress information to the first device during the process of the numerical commercial value transfer operation.

Step 303: The first device, after receiving the numerical commercial value transfer progress information sent by the server, displays the numerical commercial value transfer progress information.

According to the method according to some embodiments of the present application, the numerical commercial value transfer progress information is returned to the first device through the server during the process of the numerical commercial value transfer operation on the target object information, and the first device displays the numerical commercial value transfer progress information. A first device user of the first device (e.g., seller) and a second device user of the second device (e.g., buyer) may know the current numerical commercial value transfer progress from watching the first device's screen. Further, when a failure occurs during the numerical commercial value transfer process, the first device cannot display the numerical commercial value transfer progress information expected by the first device user and the second device user, however the users can be prompted of the failure in time, so that the first device can eliminate the failure in time, thus avoiding the loss of the first device user and the second device user, and improving the security.

Optionally, when the first device receives the numerical commercial value transfer progress information sent by the server, the prompting according to the numerical commercial value transfer progress information comprises: receiving and displaying a message indicating extracting the target object information from the graphical code from the server; receiving and displaying a message indicating the start of the numerical commercial value transfer operation from the server; receiving and displaying a message indicating an interruption of the numerical commercial value transfer operation from the server; receiving and displaying a message indicating a restart of the numerical commercial value transfer operation from the server; and receiving and display a message indicating finishing the numerical commercial value transfer operation from the server.

Optionally, after receiving and displaying a message indicating an interruption of the numerical commercial value transfer operation from the server, the first device displays a waiting option and a graphic code generating option; continuously displays the interruption message under after detecting a user selection of the waiting option, and displays a message indicating the restart of the numerical commercial value transfer operation at the server; or, the first device regenerates a graphic code according to the target object information and the first user account information after detecting a user selection of the graphic code generating option, and sends a numerical commercial value transfer stop request to the server, so that the server stops the numerical commercial value transfer operation.

Optionally, the method further comprises: displaying a time-out message when the first device does not receive the information extraction success message within a first predefined time window after generating the graphic code; displaying a time-out message when the first device does not receive the numerical commercial value transfer start message within a second predefined time window; and displaying a time-out message when the first device does not receive the numerical commercial value transfer finishing message within a third predefined time window. All the optional technical solutions mentioned above may be combined freely to form optional embodiments of the present application, and will not be repeatedly described one by one here.

FIG. 4 is a flow chart of a transaction processing method performed at the first server according to some embodiments of the present application. Referring to FIG. 4, the method comprises: Step 401: Receive a graphic code uploaded by the second device, wherein the graphic code is obtained by using the second device to scan the graphic code generated by the first device; Step 402: Parsing the graphic code to acquire the target object information and first user account information associated with the first device; and Step 403: Carrying out the numerical commercial value transfer operation on the target object information according to the target object information and first user account information associated with the first device, and sending numerical commercial value transfer progress information to the first device during the process of the numerical commercial value transfer operation, so that the first device displays the numerical commercial value transfer progress information.

According to the method according to some embodiments of the present application, the numerical commercial value transfer progress information is returned to the first device through the server during the process of the numerical commercial value transfer operation on the target object information, and the first device displays the numerical commercial value transfer progress information. A first device user and a second device user may know the current numerical commercial value transfer progress from the first device. Further, when a failure occurs during the numerical commercial value transfer process, the first device cannot display the numerical commercial value transfer progress information expected by the first device user and the second device user, however the users can be prompted of the failure in time, so that the first device can eliminate the failure in time, thus avoiding the loss of the first device user and the second device user, and improving the security. Optionally, after parsing the graphic code to acquire the target object information and first user account information associated with the first device, the method further comprises: sending a target object information extracting success message to the first device, so that the first device displays the success message of extracting the target object information.

Optionally, the step of sending the numerical commercial value transfer progress information to the first device during the process of the numerical commercial value transfer operation comprises: monitoring the progress of the numerical commercial value transfer operation during the process of the numerical commercial value transfer operation; sending the numerical commercial value transfer progress information to the first device.

Optionally, the step of sending the numerical commercial value transfer progress information to the first device comprises: sending the numerical commercial value transfer start message to the first device when detecting the start of the numerical commercial value transfer operation, so that the first device prompts the first user of the start of the numerical commercial value transfer operation; sending the numerical commercial value transfer interruption message to the first device when detecting the interruption of the numerical commercial value transfer operation, so that the first device prompts the first user of the interruption of the numerical commercial value transfer operation; sending the numerical commercial value transfer restart message to the first device when detecting the restart of the numerical commercial value transfer operation after the interruption, so that the first device prompts the first user of the restart of the numerical commercial value transfer operation; and sending the numerical commercial value transfer finishing message to the first device when detecting the finishing of the numerical commercial value transfer operation, so that the first device prompts the first user of the finishing of the numerical commercial value transfer operation. Optionally, the method further comprises: stopping the numerical commercial value transfer operation after receiving a numerical commercial value transfer stop request. All the optional technical solutions mentioned above may be combined freely to form optional embodiments of the present application, and will not be repeatedly described one by one here.

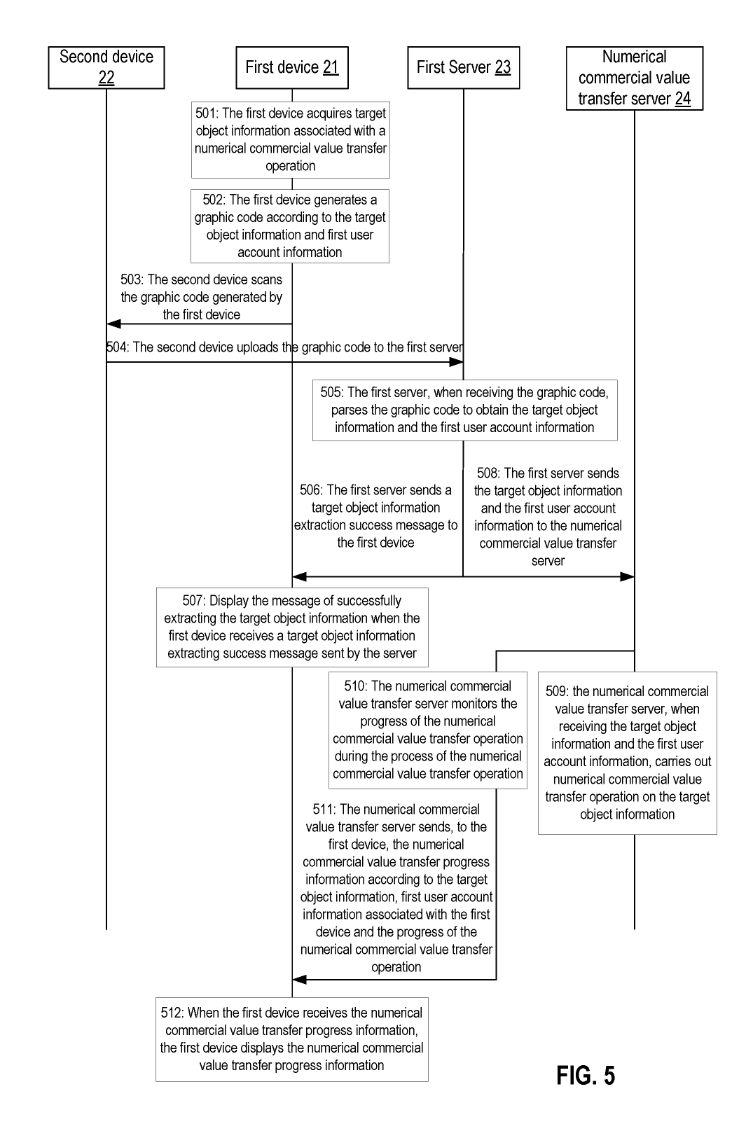

FIG. 5 is a flow chart of a transaction processing method combined with the transaction processing system according to some embodiments of the present application. Referring to FIG. 5, the method comprises:

Step 501: The first device acquires target object information associated with a numerical commercial value transfer operation.

In some embodiments of the present application, a first device user possesses one or more target objects. When a second device user hopes to possess any target object of the first device user, a numerical commercial value corresponding to the target object needs to be transferred to the first device user. The first device user transfers the target object to the second device user after confirming that the numerical commercial value transfer is finished. In order to finish a process of a numerical commercial value transfer and a process of a target object possession right transfer, the first device firstly determines the target object selected by the second device user as a target object waiting for the numerical commercial value transfer operation, and acquires the target object information waiting for the numerical commercial value transfer operation. The target object information at least comprises the numerical commercial value corresponding to the target object, and may further comprises target object number, target object description information and the like, which is not limited in some embodiments of the present application.

Accordingly, the step 501 comprises: the first device acquires the numerical commercial value inputted by the first device user as the target object information, or the first device is equipped with a scanner which is used for scanning the target object number on the target object. When the scanner scans the target object number, the first device acquires the scanned target object number, acquires the target object information corresponding to the target object number as the target object information waiting for the numerical commercial value transfer operation according to a first preset correspondence relationship. The first preset correspondence relationship comprises a pre-stored correspondence relationship between the target object number and the target object information, which may be pre-established by the first device user.

Step 502: The first device generates graphic code according to the target object information and first user account information associated with the first device. The first device information at least comprises a first device ID. The first device ID is used for uniquely confirming the first device, and may be the device number or MAC (Media Access Control) and the like of the first device. The first device information may further comprise a first device account. The first device account is used for acquiring a numerical commercial value transferred from a second device account which may be a bank account, a financial management account and the like. The first device account may be preset by the first device user and stored in the first device. The first device may generate the graphic code according to the target object information, the first device ID and the first device account, so that the numerical commercial value transfer server carries out the numerical commercial value transfer operation according to the first device account. Certainly, the first device account may further be preset by the first device user and then uploaded to the numerical commercial value transfer server to request the numerical commercial value transfer server to bind the first device account with the first device, then the numerical commercial value transfer server correspondingly saves the first device ID and the first device account. The first device generates the graphic code according to the target object information and the first device ID. When the first device ID is acquired by the numerical commercial value transfer server during a subsequent process, the numerical commercial value transfer server acquires the first device account correspondingly stored with the first device ID, and then carries out the numerical commercial value transfer operation according to the first device account. Moreover, the generated graphic code may be a QR code or a bar code and the like, which is not limited in some embodiments of the present application.

In some embodiments of the present application, the second device needs to carry out the numerical commercial value transfer operation according to the target object information and first user account information associated with the first device. However, in order to avoid the manual input of the second device user, the first device generates the graphic code according to the target object information and first user account information associated with the first device. Then the second device can obtain the target object information and first user account information associated with the first device by scanning the graphic code, which is simple, convenient and quick to operate.

Step 503: The second device scans the graphic code generated by the first device. In some embodiments of the present application, the second device is equipped with a camera and has a graphic code scanning function. The second device may scan the graphic code through the camera lens. The second device may be a smartphone, a tablet computer and the like, which is not limited in some embodiments of the present application.

Step 504: The second device uploads the graphic code to the first server. Some embodiments of the present application are illustrated by taking the example that the second device uploads the graphic code to the first server; and the first server parses the graphic code to obtain the target object information and first user account information associated with the first device. Actually, the graphic code may further be parsed by the second device to obtain the target object information and first user account information associated with the first device and then sent to the first server, which is not limited in some embodiments of the present application.

Step 505: The first server, when receiving the graphic code, parses the graphic code to obtain the target object information and first user account information associated with the first device and then carries out step 506 and step 508.

Step 506: The first server sends a target object information extracting success message according to the target object information and the first user account information.

The target object information extracting success message is used for representing that the first server has already acquired the target object information and first user account information associated with the first device and can carry out subsequent operations according to the target object information and first user account information associated with the first device.

Certainly, when the first server does not acquire the target object information and first user account information associated with the first device, an information acquiring failure message may be sent to the first device so as to prompt the first device user and the second device user that the acquisition of the target object information is failed.

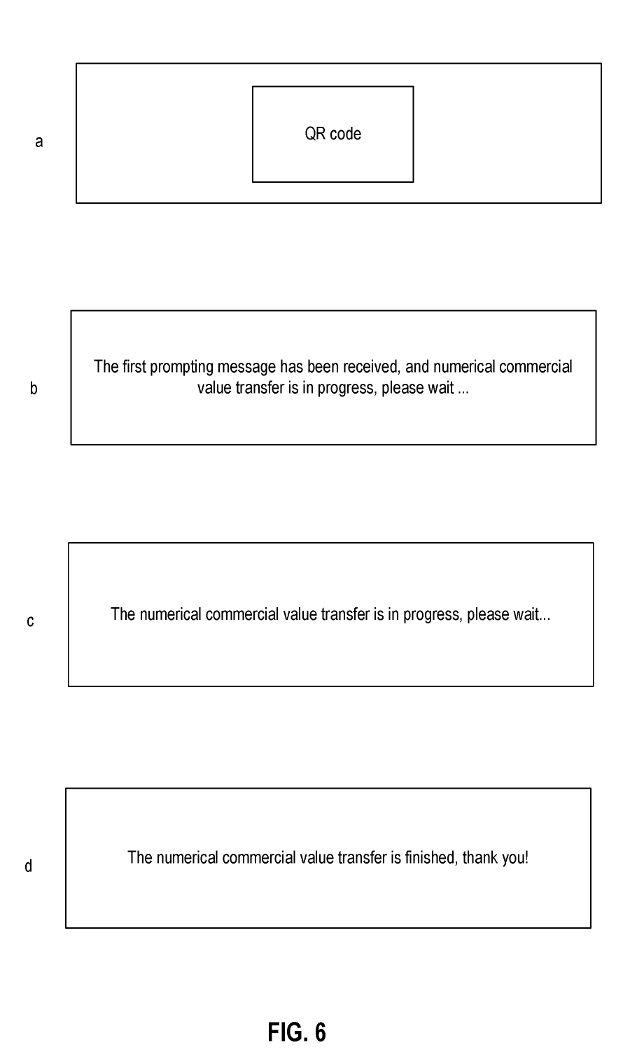

Step 507: Display the message of successfully extracting the target object information when the first device receives a target object information extracting success message sent by the server. Optionally, the first device directly displays the target object information extracting success message sent by the first server, or the first device displays a first prompting message, wherein the first prompting message is used for representing the message of successfully extracting the target object information. Referring to FIG. 6 (a), the first device displays the generated QR code. When the first device receives the target object information extracting success message, the first device switches to display that “the first prompting message has been received, and numerical commercial value transfer is in progress, please wait . . . ”, which is as shown in FIG. 6 (b).

The format of the first prompting message is preset by the first device user or preset by the first server, which is not limited in some embodiments of the present application. For example, the first device user sets the format of the first prompting message as “the information of the target object/target object number/has been received, please wait”. For a target object having a number of 235626, the first prompting message is “the information of the target object 235626 has been already received, please wait”.

In some embodiments of the present application, the first device, before receiving the target object information extracting success message, displays the graphic code all the time. When the first device receives the target object information extracting success message, the first device may cancel to display the graphic code, and switch to display the first prompting message, or continuously display the graphic code and display the first prompting message in a manner of popup. The manner of displaying the first prompting message is not limited in some embodiments of the present application.

In some embodiments of the present application, the step may be replaced by the following step: displaying the acquiring failure of the target object information when the first device receives an information acquiring failure message sent by the first server. At this time, the first device may continuously display the graphic code and display the target object information extraction failure message outside the display area of the graphic code, or display the target object information extraction failure message in a manner of popup.

Step 508: The first server sends the target object information and first user account information associated with the first device to the numerical commercial value transfer server.

Optionally, the first server sends the target object information and first user account information associated with the first device to the numerical commercial value transfer server based on TCP/IP (Transmission Control Protocol/Internet Protocol).

Step 509: the numerical commercial value transfer server, when receiving the target object information and first user account information associated with the first device, carries out numerical commercial value transfer operation on the target object information.

The numerical commercial value transfer server, when receiving the target object information and first user account information associated with the first device, transfers a numerical commercial value corresponding to the target object from the second device account to the first device account. That is, the numerical commercial value corresponding to the target object is deducted from the numerical commercial value of the second device account, and the numerical commercial value corresponding to the target object is added to the numerical commercial value of the first device account, so as to finish the numerical commercial value transfer operation on the target object information.

Before carrying out the numerical commercial value transfer operation, the numerical commercial value transfer server acquires the second device account. Optionally, the second device acquires the second device account inputted by the second device user, sends the second device account to the first server together with the graphic code, and the first server sends the second device account to the numerical commercial value transfer server. Or, the second device pre-acquires the second device account inputted by the second device user, and sends the second device account to the first server. The first server binds the second device with the second device account. When the first server receives the graphic code uploaded by the second device, the first server acquires the second device account bound with the second device, and sends the second device account to the numerical commercial value transfer server.

The manner for the numerical commercial value transfer server to acquire the second device account is not limited in some embodiments of the present application.

Step 510: The numerical commercial value transfer server monitors the progress of the numerical commercial value transfer operation during the process of the numerical commercial value transfer operation.

When the numerical commercial value transfer server carries out the numerical commercial value transfer operation, the numerical commercial value transfer operation may be interrupted due to such reasons as network environment failure or an error in first device information and the like. Therefore, in order to prompt the interruption in time, the numerical commercial value transfer server monitors the progress of the numerical commercial value transfer operation.

Step 511: The numerical commercial value transfer server sends, to the first device, the numerical commercial value transfer progress information according to the target object information, first user account information associated with the first device and the progress of the numerical commercial value transfer operation.

In some embodiments of the present application, the numerical commercial value transfer server may define a preset operation to be prompted. When the numerical commercial value transfer server carries out the preset operation, the numerical commercial value transfer server sends numerical commercial value transfer progress information corresponding to the preset operation to the first device. Optionally, the preset operation is an operation of sending an password inputting message to the second device. The numerical commercial value transfer server, when carrying out the numerical commercial value transfer operation, sends the password inputting message to the second device to ask the second device to acquire a password for numerical commercial value transfer inputted by the second device user and uploads the password for numerical commercial value transfer to the numerical commercial value transfer server. At this time, the numerical commercial value transfer server also sends the password inputting message to the first device to display the current numerical commercial value transfer progress is that the second device user inputs the passwords.

In some embodiments of the present application, the step 511 may comprise at least one of the following steps (511-1) to (511-4).

Step (511-1): When detecting the start of the numerical commercial value transfer operation, the numerical commercial value transfer server sends a numerical commercial value transfer start message according to the target object information and the first user account information.

In some embodiments of the present application, when receiving the target object information and first user account information associated with the first device, the numerical commercial value transfer server confirms the start of the numerical commercial value transfer operation, or when deducting the numerical commercial value corresponding to the target object from the numerical commercial value of the second device account, the numerical commercial value transfer server confirms the start of the numerical commercial value transfer operation, which is not limited in some embodiments of the present application.

Step (511-2): When detecting the interruption of the numerical commercial value transfer operation, the numerical commercial value transfer server sends a numerical commercial value transfer interruption message according to the target object information and the first user account information.

Optionally, when the numerical commercial value transfer server detects a failure of deducting the numerical commercial value corresponding to the target object from the second device account, the numerical commercial value transfer server confirms the interruption of the numerical commercial value transfer operation. When the numerical commercial value transfer server detects the failure of adding the numerical commercial value corresponding to the target object to the numerical commercial value of the first device account, the numerical commercial value transfer server confirms the interruption of the numerical commercial value transfer operation. When the numerical commercial value transfer server detects times of failure of deducting the numerical commercial value corresponding to the target object from the numerical commercial value of the second device account reach a preset threshold, the numerical commercial value transfer server confirms the interruption of the numerical commercial value transfer operation. When the times of failure of adding the numerical commercial value corresponding to the target object to the numerical commercial value of the first device account reach a preset threshold, the numerical commercial value transfer server confirms the interruption of the numerical commercial value transfer operation, which is not limited in some embodiments of the present application.

Step (511-3): When detecting the restart of the numerical commercial value transfer operation, the numerical commercial value transfer server sends a numerical commercial value transfer restart message according to the target object information and the first user account information.

When the numerical commercial value transfer server detects the interruption of the numerical commercial value transfer operation, the numerical commercial value transfer server does not stop the numerical commercial value transfer operation. Instead, the numerical commercial value transfer server continuously tries to carry out the numerical commercial value transfer operation. When the numerical commercial value transfer server detects that the numerical commercial value transfer operation may be continuously carried out, the numerical commercial value transfer server confirms the restart of the numerical commercial value transfer operation after the interruption, and then sends the numerical commercial value transfer restart message to the first device. Based on the step (511-3), when the numerical commercial value transfer server detects that the times of failure of deducting the numerical commercial value corresponding to the target object from the numerical commercial value of the second device account reaches the preset threshold, the numerical commercial value transfer server sends the numerical commercial value transfer interruption message according to the target object information and the first user account information; then, after the numerical commercial value transfer server detects that deducting the numerical commercial value corresponding to the target object from the numerical commercial value of the second device account is successful, the numerical commercial value transfer server send the numerical commercial value transfer restart message to the first device. Or, when the numerical commercial value transfer server confirms that the times of failure of adding the numerical commercial value corresponding to the target object to the numerical commercial value of the first device account reach the preset threshold, the numerical commercial value transfer server sends the numerical commercial value transfer interruption message according to the target object information and the first user account information; then, after the numerical commercial value transfer server detects that adding the numerical commercial value corresponding to the target object to the numerical commercial value of the first device account is successful, the numerical commercial value transfer server send the numerical commercial value transfer restart message to the first device.

Step (511-4): When detecting the finishing of the numerical commercial value transfer operation, the numerical commercial value transfer server sends a numerical commercial value transfer finishing message according to the target object information and the first user account information.

When the numerical commercial value transfer server detects that adding the numerical commercial value corresponding to the target object to the numerical commercial value of the first device account is successful, the numerical commercial value transfer server confirms that the numerical commercial value transfer operation is finished, and then sends the numerical commercial value transfer finishing message according to the target object information and the first user account information.

It should be noted that in the foregoing steps (511-1) to (511-4), the numerical commercial value transfer progress information sent by the numerical commercial value transfer server comprises the numerical commercial value transfer start message, the numerical commercial value transfer interruption message, the numerical commercial value transfer restart message and the numerical commercial value transfer finishing message. The foregoing four types of numerical commercial value transfer progress information include the same target object information, but represent different numerical commercial value transfer operation progresses. Therefore, the four types of numerical commercial value transfer progress information may be distinguished by using different progress identifications. That is, the numerical commercial value transfer server generates the numerical commercial value transfer progress information of the target object information, wherein the numerical commercial value transfer progress information comprises a progress field. When the numerical commercial value transfer server detects the start of the numerical commercial value transfer operation, the numerical commercial value transfer server fills a start identification into the progress field, and then sends the numerical commercial value transfer progress information to the first device. When the numerical commercial value transfer server detects the interruption of the numerical commercial value transfer operation, the numerical commercial value transfer server fills an interruption identification into the progress field, and then sends the numerical commercial value transfer progress information to the first device. When the numerical commercial value transfer server detects the restart of the numerical commercial value transfer operation after interruption, the numerical commercial value transfer server fills a restart identification into the progress field, and then sends the numerical commercial value transfer progress information to the first device. When the numerical commercial value transfer server detects the finishing of the numerical commercial value transfer operation, the numerical commercial value transfer server fills a finishing identification into the progress field, and then sends the numerical commercial value transfer progress information to the first device.

Step 512: When the first device receives the numerical commercial value transfer progress information, the first device displays the numerical commercial value transfer progress information.

Corresponding with the step 511, the step 512 may comprise at least one of the following steps (512-1) to (512-2).

Step (512-1): When the first device receives the numerical commercial value transfer start message sent by the server, the first device prompts the start of the numerical commercial value transfer operation.

Optionally, when the first device receives the numerical commercial value transfer start message, the first device directly displays the numerical commercial value transfer start message, or the first device displays a second prompting message, wherein the second prompting message is used for representing that the numerical commercial value transfer operation is started. Referring to FIG. 6 (b), the first device displays the first prompting message. When the first device receives the numerical commercial value transfer start message, the first device displays the second prompting message “the numerical commercial value transfer is in progress, please wait . . . ”, which is as shown in FIG. 6 (c).

Step (512-2): The first device prompts interruption of the numerical commercial value transfer operation when the first device receives the numerical commercial value transfer interruption message sent by the server. Optionally, when the first device receives the numerical commercial value transfer interruption message, the first device directly displays the numerical commercial value transfer interruption message, or the first device displays a third prompting message, wherein the third prompting message is used for representing the interruption of the numerical commercial value transfer operation.

When the numerical commercial value transfer operation is interrupted, the first device may not carry out any operation and wait the numerical commercial value transfer server to restart the numerical commercial value transfer operation. However, in order to eliminate the failure in time, the first device may display a waiting option and a graphic code generating option, wherein the graphic code generating option is used for triggering the first device to regenerate a graphic code, and requesting the numerical commercial value transfer server to stop the numerical commercial value transfer operation, and carry out an interaction process between the first device and the second device again. The waiting option and the graphic code generating option may be a button or menu item, which is not limited in some embodiments of the present application.

Accordingly, the method further comprises any one of the following steps.

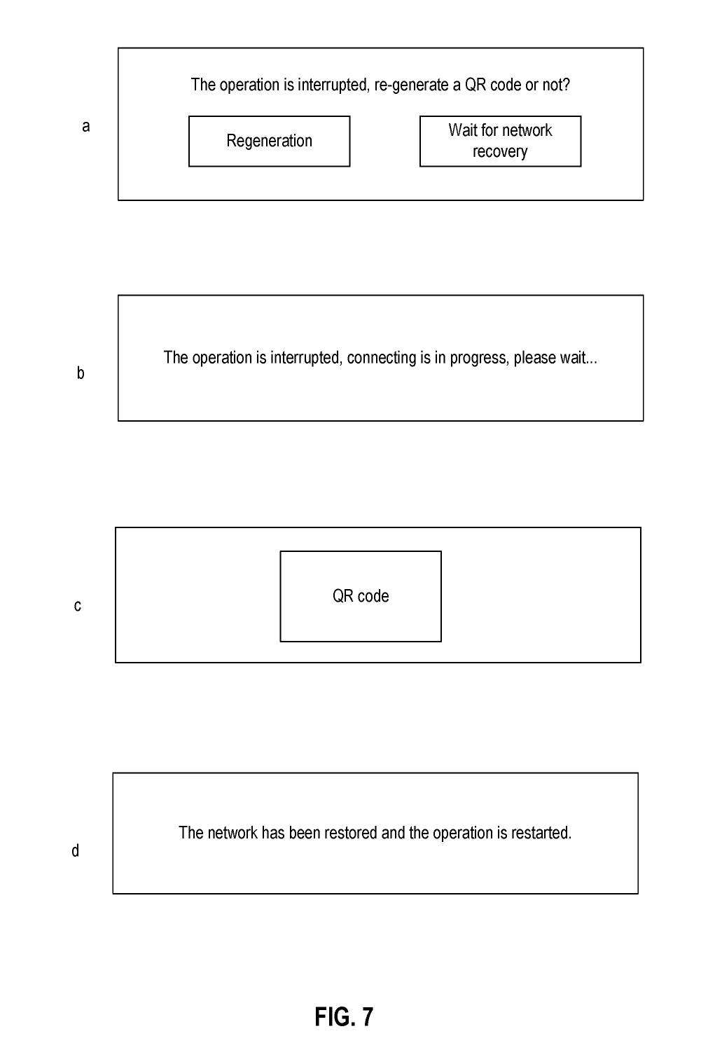

The first device continuously displays the interruption message under after detecting a user selection of the waiting option, and displays a message indicating the restart of the numerical commercial value transfer operation at the server. Optionally, when the first device receives the numerical commercial value transfer interruption message sent by the server, the first device displays the third prompting message, the waiting option and the graphic code generating option. When the first device detects the confirmation operation on the waiting option, the first device cancels to display the waiting option and the graphic code generating option, and continuously displays the third prompting message. Referring to FIG. 7 (a), the first device displays the third prompting message “the operation is interrupted, regenerate a QR code or not?” when receiving the numerical commercial value transfer interruption message, and displays a “wait for network recovery” button and a “regeneration” button. The first device, when detecting a click operation on the “wait for network recovery” button, displays “the operation is interrupted, connecting is in progress, please wait . . . ”, which is as shown in FIG. 7 (b).

The first device regenerates a graphic code according to the target object information and first user account information associated with the first device, when detecting the confirmation operation on the graphic code generating option, and sends a numerical commercial value transfer stop request to the server, so that the server stops the numerical commercial value transfer operation.

Optionally, the first device, when receiving the numerical commercial value transfer interruption message sent by the server, displays the third prompting message, the waiting option and the graphic code generating option. When the first device detects the confirmation operation on the graphic code generating option, the first device sends a numerical commercial value transfer stop request to the server, regenerates a graphic code according to the target object information and first user account information associated with the first device, and displays the regenerated graphic code. The numerical commercial value transfer server, when receiving the numerical commercial value transfer stop request, stops the numerical commercial value transfer operation. At this time, the second device re-scans the graphic code, uploads the re-scanned graphic code to the first server. The first server parses the re-scanned graphic code and extracts the target object information and first user account information associated with the first device again. The numerical commercial value transfer server carries out the numerical commercial value transfer operation again according to the target object information and first user account information associated with the first device acquired again. Referring to FIG. 7 (a), the first device regenerates a QR code when detecting a click operation on the “regeneration” button, which is as shown in FIG. 7 (c).

Step (512-3) The first device prompts restart of the numerical commercial value transfer operation when receiving a numerical commercial value transfer restart message sent by the server. Optionally, when the first device receives the numerical commercial value transfer restart message, the first device directly displays the numerical commercial value transfer restart message, or the first device displays a fourth prompting message, wherein the fourth prompting message is used for representing restart of the numerical commercial value transfer operation after interruption. Referring to FIG. 7 (d), the first device displays the fourth prompting message “the network problem has been restored and the operation is restarted” when receiving the numerical commercial value transfer restart message.

Step (512-4) The first device prompts finishing of the numerical commercial value transfer operation when receiving a numerical commercial value transfer finishing message sent by the server.

Optionally, when the first device receives the numerical commercial value transfer finishing message, the first device directly displays the numerical commercial value transfer finishing message, or the first device displays a fifth prompting message, wherein the fifth prompting message is used for representing the finishing of the numerical commercial value transfer operation. Referring to FIG. 6 (c), the first device displays the second prompting message. When the first device receives the numerical commercial value transfer finishing message, the first device displays the fifth prompting message “the numerical commercial value transfer is finished, thank you . . . ”, which is shown in FIG. 6 (d).

It should be noted that the first device, when receiving numerical commercial value transfer progress information in each time, may switch the current display interface into the numerical commercial value transfer progress information received in this time, and may further display the graphic code all the time, and display the numerical commercial value transfer progress information received this time in a manner of popup when receiving the numerical commercial value transfer progress information in each time, which is not limited in some embodiments of the present application. In some embodiments of the present application, the first device may receive the target object information extracting success message, the numerical commercial value transfer start message, and the numerical commercial value transfer finishing message in sequence. During this process, the first device may receive the numerical commercial value transfer interruption message and the numerical commercial value transfer restart message. However, when the network between the numerical commercial value transfer server and the first device is failed, the numerical commercial value transfer server cannot send messages to the first device, and the first device cannot receive the messages either, which cannot achieve the objective of effective prompting. Therefore, in order to eliminate the trouble in time, the first device may set numerical commercial value transfer progress information expected to receive after each numerical commercial value transfer progress information. Once one numerical commercial value transfer progress information is received and next expected numerical commercial value transfer progress information is not received, time-out of receiving the numerical commercial value transfer progress information will be prompted to the first device user.

Optionally, the first device displays the time-out message of extracting the target object information when the first device does not receive the target object information extracting success message in a first predefined time window after generating the graphic code. The first device displays the time-out message of confirming the target object information when the first device does not receive the numerical commercial value transfer start message in a second predefined time window after prompting the message of successfully extracting the target object information. The first device displays the time-out message of carrying out the numerical commercial value transfer operation when the first device does not receive the numerical commercial value transfer finishing message in a third predefined time window after prompting the start of the numerical commercial value transfer operation. The first predefined time window, the second predefined time window and the third predefined time window may be set by the first device user or determined according to a time interval between every two numerical commercial value transfer progress information received by the first device in a historical application process, which is not limited in some embodiments of the present application.

It should be noted that some embodiments of the present application are illustrated by only taking the four progresses including numerical commercial value transfer start, numerical commercial value transfer interruption, numerical commercial value transfer restart and numerical commercial value transfer finishing as examples. Actually, when the numerical commercial value transfer server carries out such operations as asking the second device to upload a password for numerical commercial value transfer, receiving the password for numerical commercial value transfer uploaded by the second device and the like, the numerical commercial value transfer server can send corresponding numerical commercial value transfer progress information to the first device, so that the numerical commercial value transfer progress information displayed by the first device is synchronous with the information displayed by the second device. Different from the first device which displays the graphic code all the time, when the numerical commercial value transfer progress information displayed by the first device is synchronous with the information displayed by the second device, the second device user may confirm the numerical commercial value transfer server is carrying out the numerical commercial value transfer operation, thus enhancing the credibility.

It should be further noted that some embodiments of the present application are illustrated by taking that the first device generates one graphic code for one second device user for example. Actually, when the second device user expects to transfer a plurality of target objects, a plurality of second device users may possibly exist. At this time, the first device generates a plurality of graphic codes according to the target object information selected by each second device user, and distinguishes interfaces corresponding to each second device user by using different numbers. When an operation of selecting any number is detected, the first device switches to the interface corresponding to the number, and displays such information as the graphic code corresponding to the number, the target object information extracting success message, the numerical commercial value transfer start message and the like. According to the method according to some embodiments of the present application, the numerical commercial value transfer progress information is returned to the first device through the server during the process of the numerical commercial value transfer operation on the target object information according to the graphic code, and the first device displays the numerical commercial value transfer progress information. The first device user and the second device user may know the current numerical commercial value transfer progress from the first device. Further, when a failure occurs during the numerical commercial value transfer process, the first device cannot display the numerical commercial value transfer progress information expected by the first device user and the second device user, however the users can be prompted of the failure in time, so that the first device can eliminate the failure in time, thus avoiding the loss of the first device user and the second device user, and improving the security.

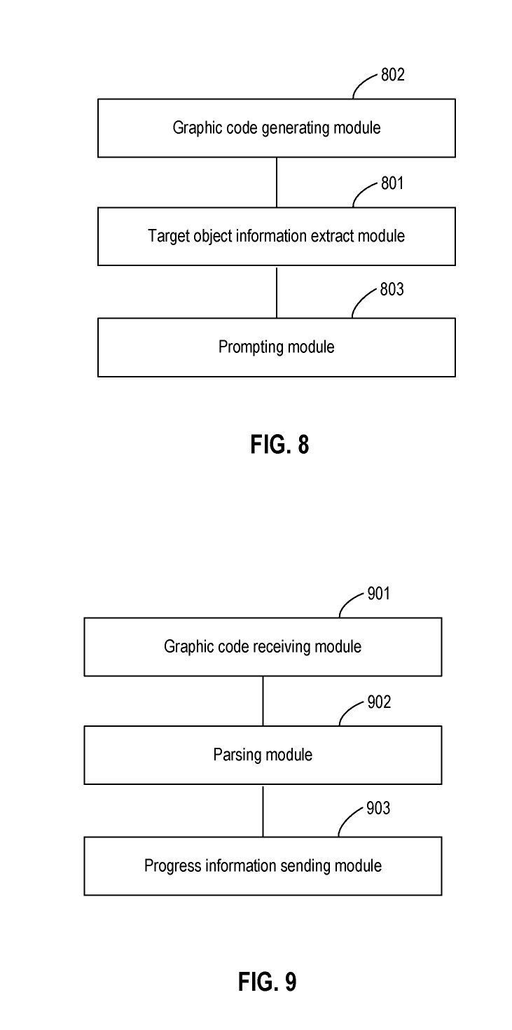

FIG. 8 is a structural block diagram of a transaction processing apparatus according to some embodiments of the present application. Referring to FIG. 8, the apparatus comprises:
a target object information extraction module 801, used for acquiring target object information associated with a numerical commercial value transfer operation;
a graphic code generating module 802 connected with the target object information extraction module 801 and used for generating the graphic code according to the target object information and first user account information associated with the first device so that a second device scans and uploads the graphic code to a server, wherein the server carries out the numerical commercial value transfer operation of the target object information according to the graphic code, and returns numerical commercial value transfer progress information according to the target object information and first user account information associated with the first device during the process of the numerical commercial value transfer operation; and
a prompting module 803 connected with the target object information extraction module 801 and used for prompting according to the numerical commercial value transfer progress information when receiving the numerical commercial value transfer progress information sent by the server.

Optionally, the prompting module 803 comprises: a first prompting unit used for prompting acquiring success of the target object information when receiving a target object information extracting success message sent by the server; a second prompting unit used for prompting start of the numerical commercial value transfer operation when receiving a numerical commercial value transfer start message sent by the server; a third prompting unit used for prompting interruption of the numerical commercial value transfer operation when receiving a numerical commercial value transfer interruption message sent by the server; a fourth prompting unit used for prompting restart of the numerical commercial value transfer operation when receiving a numerical commercial value transfer restart message sent by the server; and a fifth prompting unit used for prompting finishing of the numerical commercial value transfer operation when receiving a numerical commercial value transfer finishing message sent by the server.

Optionally, the apparatus further comprises: an options display module used for displaying a waiting option and a graphic code generating option; a first confirming module used for continuously prompting the interruption of the numerical commercial value transfer operation when detecting a confirmation operation on the waiting option, and prompting the restart of the numerical commercial value transfer operation when receiving the numerical commercial value transfer restart message sent by the server; or, a second confirmation module used for regenerating a graphic code according to the target object information and the first user account information after detecting a user selection of the graphic code generating option, and sending a numerical commercial value transfer stop request to the server, so that the server stops the numerical commercial value transfer operation. Optionally, the apparatus further comprises: a first time-out prompting module used for prompting time-out of acquiring the target object information when target object information extracting success message is not acquired in a first predefined time window after generating the graphic code; a second time-out prompting module used for prompting the time-out of confirming the target object information when not receiving the numerical commercial value transfer start message in a second predefined time window after displaying the message of successfully extracting the target object information; and a third time-out prompting module used for prompting the time-out of carrying out the numerical commercial value transfer operation when not receiving the numerical commercial value transfer finishing message in a third predefined time window after prompting the start of the numerical commercial value transfer operation. According to the apparatus according to some embodiments of the present application, the numerical commercial value transfer progress information is returned to the first device through the server during the process of the numerical commercial value transfer operation on the target object information according to the graphic code, and the first device displays the numerical commercial value transfer progress information. The first device user and the second device user may know the current numerical commercial value transfer progress from the first device. Further, when a failure occurs during the numerical commercial value transfer process, the first device cannot display the numerical commercial value transfer progress information expected by the first device user and the second device user, however the users can be prompted of the failure in time, so that the first device can eliminate the failure in time, thus avoiding the loss of the first device user and the second device user, and improving the security.

FIG. 9 is a structural block diagram of a transaction processing apparatus according to some embodiments of the present application. Referring to FIG. 9, the apparatus comprises:
a graphic code receiving module 901 used for receiving a graphic code uploaded by the second device, wherein the graphic code is obtained by using the second device to scan the graphic code generated by the first device;
a parsing module 902 connected with the graphic code receiving module 901 and used for parsing the graphic code so as to acquire target object information and first device information; and
a progress information sending module 903 connected with the parsing module 902 and used for carrying out a numerical commercial value transfer operation on the target object information according to the target object information and first user account information associated with the first device and sending the numerical commercial value transfer progress information to the first device during the process of the numerical commercial value transfer operation, so that the first device makes a prompt according to the numerical commercial value transfer progress information.

Optionally, the apparatus further comprises: an acquisition message sending module used for sending a target object information extracting success message according to the target object information and the first user account information, so that the first device displays the success message of extracting the target object information. Optionally, the progress information sending module 903 comprises: a progress monitoring unit used for monitoring the progress of the numerical commercial value transfer operation during the process of the numerical commercial value transfer operation; and an information sending unit used for sending the numerical commercial value transfer progress information to the first device according to the target object information, first user account information associated with the first device and the progress of the numerical commercial value transfer operation.

Optionally, the information sending unit comprises: a first sending sub-unit used for sending a numerical commercial value transfer start message to the first device when detecting the start of the numerical commercial value transfer operation, so that the first device prompts the start of the numerical commercial value transfer operation; a second sending sub-unit used for sending a numerical commercial value transfer interruption message to the first device when detecting the interruption of the numerical commercial value transfer operation, so that the first device prompts the interruption of the numerical commercial value transfer operation; a third sending sub-unit used for sending a numerical commercial value transfer restart message to the first device when detecting the restart of the numerical commercial value transfer operation after the interruption, so that the first device prompts the restart of the numerical commercial value transfer operation; and a fourth sending sub-unit used for sending a numerical commercial value transfer finishing message to the first device when detecting the finishing of the numerical commercial value transfer operation, so that the first device prompts the finishing of the numerical commercial value transfer operation.

Optionally, the apparatus further comprises: an operation stopping module used for stopping the numerical commercial value transfer operation when receiving a numerical commercial value transfer stop request sent by the first device. According to the apparatus according to some embodiments of the present application, the numerical commercial value transfer progress information is returned to the first device through the server during the process of the numerical commercial value transfer operation on the target object information according to the graphic code, and the first device displays the numerical commercial value transfer progress information. The first device user and the second device user may know the current numerical commercial value transfer progress from the first device. Further, when a failure occurs during the numerical commercial value transfer process, the first device cannot display the numerical commercial value transfer progress information expected by the first device user and the second device user, and can prompt the occurred failure in time, so that the first device can eliminate the failure in time, thus avoiding the loss of the first device user and the second device user, and improving the security.

It should be noted that the transaction processing apparatus provided by the foregoing embodiments is divided, for example, into the foregoing function modules for processing transaction. In practical application, the foregoing function may be distributed to different functional modules according to demands. That is, internal structures of the first device, the first server and the numerical commercial value transfer server are divided into different functional modules, so as to finish all or partial functions described above. Moreover, the transaction processing apparatus belongs to the same concept as the transaction processing method, and the specific implementation process of the transaction processing apparatus can be seen in the embodiments of the method, and will not be described repeatedly herein.

The aforementioned embodiments are directed to a method of processing a transaction in connection with a transfer of monetary value at a remote server. In this process, the first device (e.g., a POS machine) displays a graphic code (e.g., a QR code) associated with the transaction and then receives one or more messages from the remote server representing different stages of this transaction from beginning to the end. In some other embodiments, the transaction processing method disclosed in the present application may be used for exchanging information (e.g., contact information) between two mobile devices without triggering any monetary transfer at the remote server. For example, the wide spread of smartphones triggers many widely-used social networking applications. A user logs into his/her user account at a social networking application from a smartphone to exchange information with other users through, e.g., a chat session. As described below, the initiation of any chat session between two users of a social networking application requires that each user have the other user's user account information at the social networking application.

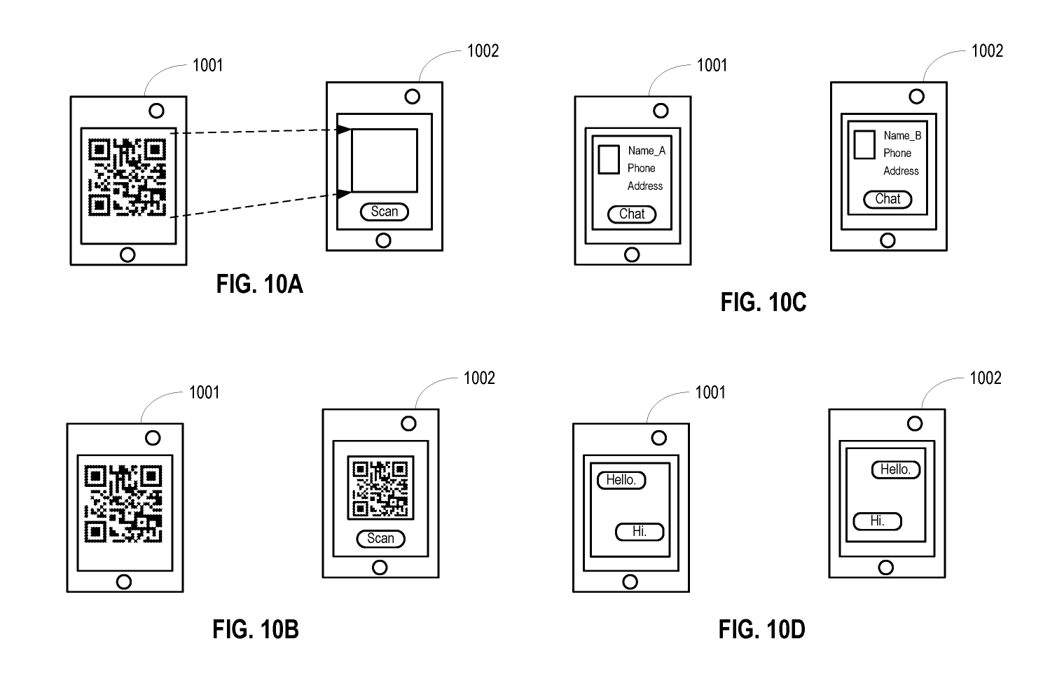

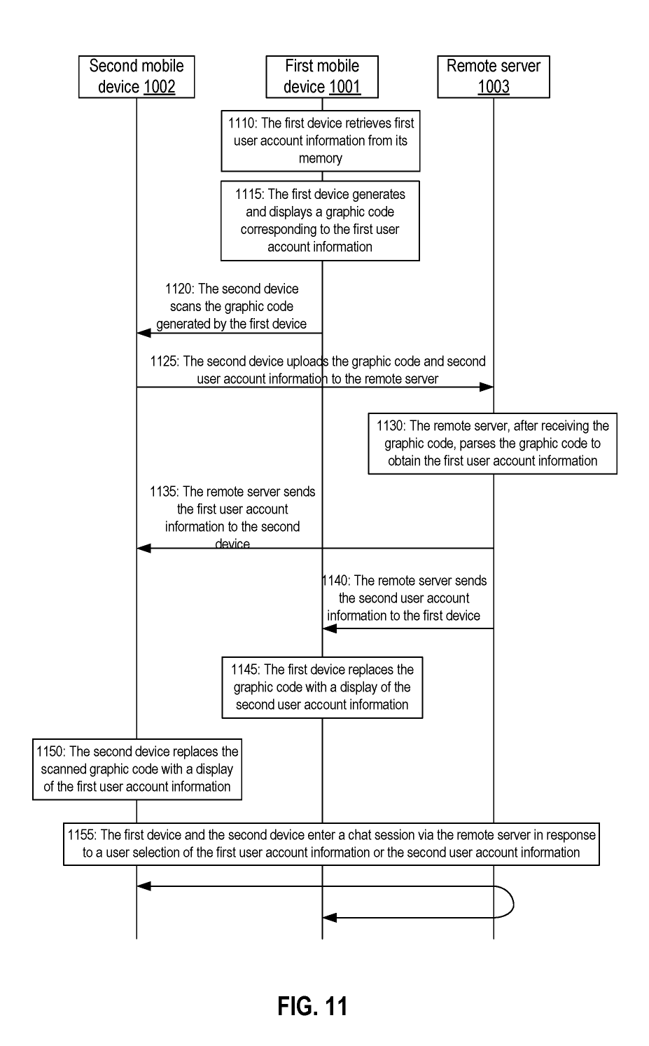

According to some embodiments, the method disclosed in the present application can be used for facilitating the exchange of user account information between two users of mobile devices. In particular, FIGS. 10A-10D are structural block diagrams of two mobile devices exchanging user account information via a remote server; and FIG. 11 is a flow chart of the user account information exchange method performed at the two mobile devices and the remote server according to some embodiments of the present application.

As shown in FIG. 11, a first user of the first mobile device 1001 initially retrieves (1110) first user account information from its memory. As noted above, when the first user logs into his/her account at the social networking application, the first user needs to provide his/her user name and password. Accordingly, the first mobile device 1001 generates the first user account information unique to the first user and stores it in the memory of the first mobile device 1001. In some embodiments, the remote server 1003 is responsible for generating the first user account information and returning the information to the first mobile device 1001.

Next, the first mobile device 1001 generates (1115) a graphic code corresponding to the first user account information and displays the graphic code on the screen of the first mobile device 1001. FIG. 10A depicts the first mobile device 1001 having a QR code displayed on its screen. In some embodiments, the first user account information (e.g., the user name of the first user at the social networking application) is encoded into the QR code. Assuming that the first user of the first mobile device 1001 and the second user of the second mobile device 1002 meet each other for the first time and would like to exchange user account information so that they can exchange text messages in the future, the second user of the second mobile device 1002 then starts its camera to scan (1120) the graphic code displayed on the screen of the first mobile device 1001 (see, e.g., FIG. 10A). As shown in FIG. 10B, both the first mobile device 1001 and the second mobile device 1002 have a display of the graphic code on their screens at the end of the scanning processing.

After capturing the graphic code, the second mobile device 1002 automatically uploads (1125) the graphic code and second user account information to the remote server 1003. In some other embodiments, only the remote server 1003 is capable of extracting user account information from a graphic code (e.g., the QR code) and the second mobile device 1002 has to upload the graphic code. In other embodiments, the second mobile device 1002 itself is capable of extracting the first user account information from the captured QR code such that the second mobile device 1002 uploads the first and second user account information to the remote server 1003.

Upon receipt of the uploaded information, the remote server 1003 parses (1130) the graphic code to obtain the first user account information. Next, the remote server 1003 sends (1135) the first user account information to the second mobile device 1002 and sends (1140) the second user account information to the first mobile device 1001. In other words, both the first and second users receive the other user's account information at the end of the two steps via the remote server 1003. In response, as shown in FIG. 10C, the first mobile device 1001 replaces (1145) the graphic code with a display of the second user account information (e.g., name, phone number, address, etc.) and the second mobile device 1002 replaces (1150) the scanned graphic code with a display of the first user account information. Note that some of the contact information displayed on the screens (e.g., phone number or address) is stored in the remote server 1003 and pushed down to the two mobile devices along with the respective user account information (e.g., user identifiers of the first and second users at the social networking application). In some embodiments, the remote server 1003 also updates the contact list of the first user's account at the social networking application by adding the second user account information to the contact list and updates the contact list of the second user's account at the social networking application by adding the first user account information to the contact list.

As shown in FIG. 10C, each screen includes a chat icon through which a user can start a chat session with the other user displayed on the screen. In this case, the first user's name is “Name_B” and the second user's name is “Name_A”. By pressing the chat icon on the first mobile device 1001, the first user initiates (1155) a chat session with the second user by sending a chat request to the remote server 1003, which triggers the second mobile device 1002 to enter the same chat session as shown in FIG. 10D. Similarly, the second user can also initiate a chat session with the first user by pressing the chat icon on the screen of the second mobile device 1002. In some embodiments, the two mobile devices display the contact information as shown in FIG. 10C for a predefined time period (e.g., 3-5 seconds) and then enters the chat session as shown in FIG. 10D without requiring further user instruction.

In some embodiments, both the first mobile device 1001 and the second mobile device 1002 update their respective contact list in accordance with the second and first user account information. For example, the first mobile device 1001 may first check whether the second user account information corresponds to an entry in a contact list of the first mobile device. When there is an existing entry corresponding to the second user account information, the first mobile device 1001 then updates the entry in the contact list in accordance with the second user account information. When there is no entry corresponding to the second user account information, the first mobile device 1002 then generates a new entry in the contact list in accordance with the second user account information.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present invention. First ranking criteria and second ranking criteria are both ranking criteria, but they are not the same ranking criteria.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A method of performing a transaction related to a target object at a first device having a screen, one or more processors, and memory storing one or more program modules to be executed by the one or more processors, the method comprising:
acquiring target object information associated with a numerical commercial value transfer operation;
generating a graphic code according to the target object information and first user account information associated with the first device;
displaying the graphical code on the screen so that a second device can scan the graphic code and upload the graphic code to a server, wherein the server is configured to extract the target object information and the first user account information from the graphical code, carry out the numerical commercial value transfer operation on the target object information, and return numerical commercial value transfer progress information to the first device during the process of the numerical commercial value transfer operation; and
receiving and displaying the numerical commercial value transfer progress information on the screen.

2. The method of claim 1, wherein receiving and displaying the numerical commercial value transfer progress information on the screen further comprises:
receiving and displaying a message indicating the extract of the target object information from the graphical code from the server;
receiving and displaying a message indicating the start of the numerical commercial value transfer operation from the server;
receiving and displaying a message indicating an interruption of the numerical commercial value transfer operation from the server;
receiving and displaying a message indicating a restart of the numerical commercial value transfer operation from the server; and
receiving and display a message indicating finishing the numerical commercial value transfer operation from the server.

3. The method of claim 2, further comprising:
after receiving and displaying a message indicating an interruption of the numerical commercial value transfer operation from the server, displaying a waiting option and a graphic code generating option on the screen.

4. The method of claim 3, further comprising:
continuously displaying the interruption message under after detecting a user selection of the waiting option; and
displaying a message indicating the restart of the numerical commercial value transfer operation at the server.

5. The method of claim 3, further comprising:
regenerating a graphic code according to the target object information and the first user account information after detecting a user selection of the graphic code generating option; and
sending a numerical commercial value transfer stop request to the server, so that the server stops the numerical commercial value transfer operation.

6. The method of claim 2, further comprising:
displaying a time-out message when the first device does not receive the information extraction success message within a first predefined time window after generating the graphic code;
displaying a time-out message when the first device does not receive the numerical commercial value transfer start message within a second predefined time window; and
displaying a time-out message when the first device does not receive the numerical commercial value transfer finishing message within a third predefined time window.

7. The method of claim 1, further comprising:
stopping the numerical commercial value transfer operation after receiving a numerical commercial value transfer stop request from the server.

8. A first device having a screen, one or more processors, memory, and one or more program modules stored in the memory and to be executed by the one or more processors, wherein the one or more program modules further include instructions for:
acquiring target object information associated with a numerical commercial value transfer operation;
generating a graphic code according to the target object information and first user account information associated with the first device;
displaying the graphical code on the screen so that a second device can scan the graphic code and upload the graphic code to a server, wherein the server is configured to extract the target object information and the first user account information from the graphical code, carry out the numerical commercial value transfer operation on the target object information, and return numerical commercial value transfer progress information to the first device during the process of the numerical commercial value transfer operation; and
receiving and displaying the numerical commercial value transfer progress information on the screen.

9. The first device of claim 8, wherein the instruction for receiving and displaying the numerical commercial value transfer progress information on the screen further includes instructions for:
receiving and displaying a message indicating the extract of the target object information from the graphical code from the server;
receiving and displaying a message indicating the start of the numerical commercial value transfer operation from the server;
receiving and displaying a message indicating an interruption of the numerical commercial value transfer operation from the server;
receiving and displaying a message indicating a restart of the numerical commercial value transfer operation from the server; and
receiving and display a message indicating finishing the numerical commercial value transfer operation from the server.

10. The first device of claim 9, wherein the one or more program modules further include instructions for:
after receiving and displaying a message indicating an interruption of the numerical commercial value transfer operation from the server, displaying a waiting option and a graphic code generating option on the screen.

11. The first device of claim 10, wherein the one or more program modules further include instructions for:
continuously displaying the interruption message under after detecting a user selection of the waiting option; and
displaying a message indicating the restart of the numerical commercial value transfer operation at the server.

12. The first device of claim 10, wherein the one or more program modules further include instructions for:
regenerating a graphic code according to the target object information and the first user account information after detecting a user selection of the graphic code generating option; and
sending a numerical commercial value transfer stop request to the server, so that the server stops the numerical commercial value transfer operation.

13. The first device of claim 9, wherein the one or more program modules further include instructions for:
displaying a time-out message when the first device does not receive the information extraction success message within a first predefined time window after generating the graphic code;
displaying a time-out message when the first device does not receive the numerical commercial value transfer start message within a second predefined time window; and
displaying a time-out message when the first device does not receive the numerical commercial value transfer finishing message within a third predefined time window.

14. The first device of claim 8, wherein the one or more program modules further include instructions for:
stopping the numerical commercial value transfer operation after receiving a numerical commercial value transfer stop request from the server.

15. The first device of claim 8, wherein the first device is a point of sale machine and the second device is a mobile phone.

16. A method performed at a first mobile device of exchanging contact information with a second mobile device, each mobile device having a screen, one or more processors, and memory storing one or more program modules to be executed by the one or more processors, the method comprising:
retrieving first user account information from its memory;
generating a graphic code corresponding to the first user account information and displaying the graphic code on its screen, wherein the second mobile device is configured to scan the graphic code and upload the graphic code and second user account information to a remote server;
receiving the second user account information from the remote server;
replacing the graphic code with a display of the second user account information on its screen; and
initiating a chat session with the second mobile device.

17. The method of claim 16, further comprising updating its contact list in accordance with the second user account information.

18. The method of claim 17, wherein updating its contact list in accordance with the second user account information further includes:
determining whether the second user account information corresponds to an entry in a contact list of the first mobile device;
updating the entry in the contact list in accordance with the second user account information when there is an existing entry corresponding to the second user account information; and
generating a new entry in the contact list in accordance with the second user account information when there is no entry corresponding to the second user account information.

19. The method of claim 16, wherein the second mobile device is configured to receive the first user account information from the remote server and update its contact list in accordance with the first user account information.

20. The method of claim 16, wherein the chat session is initiated in response to detecting a user instruction to the first mobile device.
